(19) United States
(12) Patent Application Publication
(10) Pub. No.: US 2024/0129440 A1
(43) Pub. Date: Apr. 18, 2024

(54) CONTROL APPARATUS, DISPLAY APPARATUS, IMAGING SYSTEM, CONTROL METHOD, AND STORAGE MEDIUM

(71) Applicant: CANON KABUSHIKI KAISHA, Tokyo (JP)

(72) Inventor: JUNICHI SUZUKI, Tochigi (JP)

(21) Appl. No.: 18/470,583

(22) Filed: Sep. 20, 2023

(30) Foreign Application Priority Data
Oct. 13, 2022 (JP) 2022-164402

(51) Int. Cl. H04N 7/18; G09G 3/20

(52) U.S. Cl. CPC H04N 7/183; G09G 3/20; G09G 2340/04; G09G 2354/00

(57) ABSTRACT

A control apparatus is communicable with a unit including a display apparatus in an imaging system. The control apparatus includes a communication device configured to communicate with the unit, and a processor configured to make the communication device to transmit display data superimposed by the display apparatus to the unit based on specifying information for specifying the unit acquired by the communication device and information about a function of the display apparatus corresponding to the specifying information.

### BACKGROUND

### Technical Field

One of the aspects of the embodiments relates to a control apparatus, a display apparatus, an imaging system, a control method, and a storage medium.

### Description of Related Art

A conventional imaging system includes a control apparatus in a lens apparatus etc. and a display apparatus in at least one imaging apparatus communicable with the control apparatus. Japanese Patent Laid-Open No. 2016-012832 discloses a control apparatus (camera) configured to specify a function of the camera apparatus based on an imaging condition specified for the camera apparatus in a camera system including a plurality of camera apparatuses. Japanese Patent Laid-Open No. 2012-094955 discloses a control apparatus (camera) configured to measure its position and displays an image based on peripheral information on its position superimposed on a through (live-view) image.

In an imaging system involving a plurality of users, information necessary for the user who observes a display apparatus in the imaging system may not be displayed. This is not suitable for the operability of an imaging unit operated by the user.

### SUMMARY

A control apparatus according to one aspect of the embodiment is communicable with a unit including a display apparatus in an imaging system. The control apparatus includes a communication device configured to communicate with the unit, and a processor configured to make the communication device to transmit display data superimposed by the display apparatus to the unit based on specifying information for specifying the unit acquired by the communication device and information about a function of the display apparatus corresponding to the specifying information. A control method corresponding to the control apparatus also constitutes another aspect of the embodiment. A storage medium storing a program that causes a computer to execute the above control method also constitutes another aspect of the embodiment. An imaging system including the above control apparatus also constitutes another aspect of the embodiment.

Further features of the disclosure will become apparent from the following description of embodiments with reference to the attached drawings.

### BRIEF DESCRIPTION OF THE DRAWINGS

FIG. 1 is a block diagram of an imaging system according to a first embodiment.

FIG. 2 is a flowchart illustrating function specifying processing according to the first and second embodiments.

FIG. 3 is a flowchart illustrating display specifying processing according to the first and second embodiments.

FIG. 4 is a flowchart illustrating display content determining processing according to the first and second embodiments.

FIG. 5 is a flowchart illustrating display information creating processing according to each embodiment.

FIGS. 6A and 6B are examples of user interfaces (UIs) according to the first embodiment.

FIGS. 7A, 7B, and 7C are an example of functions and display specifics according to each embodiment.

FIG. 8 is a block diagram of an imaging system according to the second embodiment.

FIGS. 9A, 9B, and 9C are examples of UIs according to the second embodiment.

FIG. 10 is a block diagram of an imaging system according to a third embodiment.

FIG. 11 is a flowchart illustrating function specifying processing according to the third embodiment.

FIG. 12 is a flowchart illustrating display specifying processing according to the third embodiment.

FIG. 13 is a flowchart illustrating display content determining processing according to the third embodiment.

FIGS. 14A, 14B, 14C, and 14D are examples of UIs according to the third embodiment.

FIG. 15 is a block diagram of an imaging system according to a fourth embodiment.

FIG. 16 is a block diagram of an imaging system as a variation of the fourth embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

A description will now be given of problems of a conventional imaging system that includes a control apparatus such as a lens apparatus and at least one display apparatus communicable with the control apparatus. The information transmitted and received between devices in the imaging system includes images and video information, and since it is assumed that a general video information transmission and communication protocol is available, menu information such as device status and settings may not be applicable. The imaging system may include a plurality of connected display apparatus (external UI) having a display unit other than a lens, such as an accessory for operating a camera VF and a lens, and a display dedicated apparatus such as a monitor and a tablet. Recently, due to the diversification of imaging applications, devices connected to the lens are also diversified. Simply displaying predetermined information on a communicably connected display apparatus may not provide necessary information for a photographer, for example.

The imaging system involves a variety of functions such as a photographer who operates a camera and a lens, a video engineer (VE) who adjusts a camera and a variety of video devices, and a switcher who switches between screens in video production. In some cases, there are more detailed divisions such as a focusing person who specializes in a focus lens operation and a person who adjusts an angle of view.

In the imaging environment, a variety of UIs may be configured in a variety of places such as the camera VF, camera accessories, lenses, and lens accessories, and VEs and switchers. Especially recently, the number of devices connectible to PCs and tablets is increasing, and these devices are sometimes used as the UI of the imaging system.

Depending on these various functions, the operation contents and confirmation items are different. For example, a photographer needs information about an imaging operation, but a VE or switcher needs information about the entire system. A display format and information suitable for each type of UI is different. For example, a large display unit is more suitable for list display. Since video is displayed for the VF, superimposed display of a lot of information will negatively affect imaging.

Depending on the camera or other IFs, there are communicable information and uncommunicable information. Whether or not the information is communicable may depend on the product generation or the firmware version. In any case, duplicate information display may be avoided between communicably connected devices while necessary information is displayed.

In order to improve the user's operability during imaging, the display of the external UI may be always necessary for a person viewing the UI. These Uls are to have a display format that matches the Ua I display ability, and information that matches the function of the person viewing the UI in the entire imaging system and the function of the UI itself. Therefore, an information storing apparatus (storage apparatus or memory) configured to store the information may be able to specify the functions of a photographer and an operator, a display unit of a communicably connected device, and determine the content to be displayed on the external UI based on the specified information.

Each embodiment will be described in detail below.

### First Embodiment

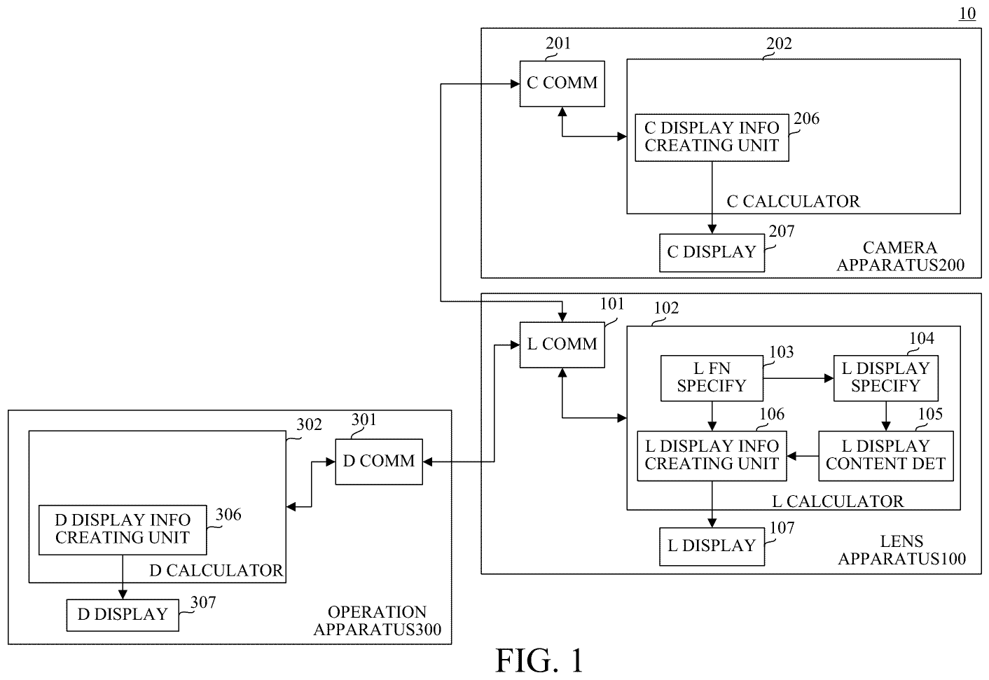

Referring now to FIG. 1, a description will be given of an imaging system 10 according to a first embodiment. FIG. 1 is a block diagram of the imaging system 10. The imaging system 10 includes a lens apparatus 100, a camera apparatus 200, and an operation apparatus 300. In this embodiment, the lens apparatus 100 serves as an information storing apparatus (control apparatus), the camera apparatus 200, and the operation apparatus 300 serve as external UIs (units including a display apparatus). In this embodiment, the operation apparatus 300 is, for example, an accessory for operating the zoom lens of the lens apparatus 100, but is not limited to this example.

A description will now be given of the lens apparatus 100. The lens apparatus 100 includes an L communication unit 101, an L calculator (processor) 102, and an L display unit 107. The lens apparatus 100 includes a lens unit (zoom lens, focus lens), an aperture stop, an operation unit (none of which is illustrated), and the like. The L communication unit 101 is a communication device that communicates with another communicably connected device such as the camera apparatus 200 and the operation apparatus 300. The L communication unit 101 transmits data input from the L calculator 102 to the other communicably connected device, and outputs received data from the other communicably connected device to the L calculator 102. In this embodiment, the L communication unit 101 outputs at least identification (ID) information received from the other communicably connected device to the L calculator 102. The L communication unit 101 also outputs C display data, which will be described below, to the camera apparatus 200 and outputs D display data to the operation apparatus 300.

The L calculator 102 is a control unit such as a CPU, and includes at least an L function specifying unit 103, an L display specifying unit 104, an L display content determining unit 105, and an L display information creating unit 106. The L calculator 102 also outputs L display data, which will be described below, to the L display unit 107, and outputs display data other than the L display data (C display data, D display data) to the L communication unit 101.

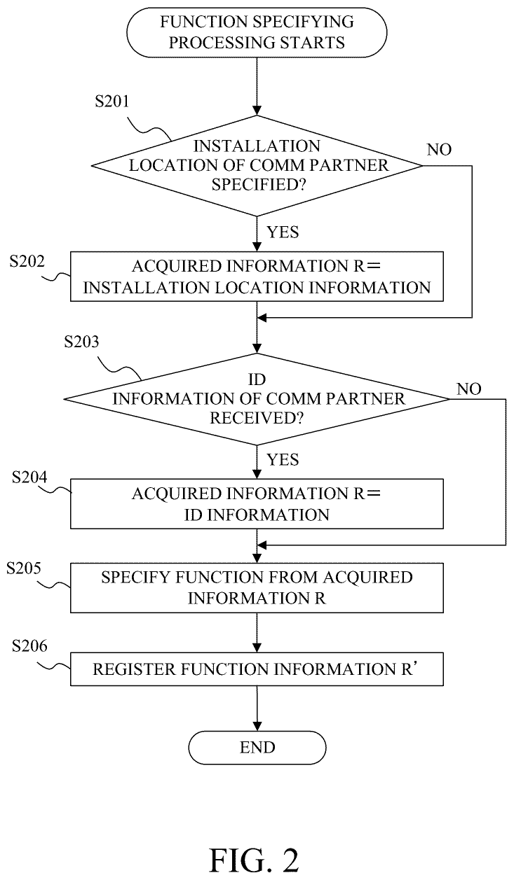

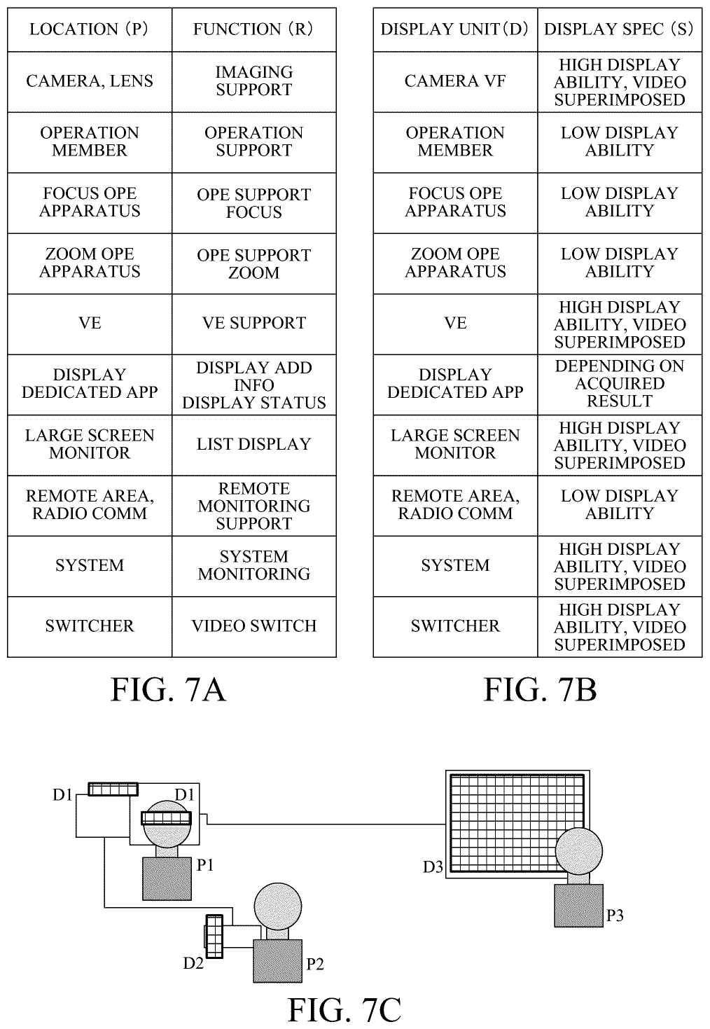

The L function specifying unit 103 performs function specifying processing that specifies a function (user's type) of the user (operator or photographer) operating each device based on the ID information on each device input from the L communication unit 101 in the imaging system 10 including the lens apparatus 100. The specified function information is handled by the L display specifying unit 104, the L display content determining unit 105, and the L display information creating unit 106. A detailed processing flow of the function specifying processing will be described below with reference to FIG. 2. The term “function” will also be discussed below with reference to FIGS. 7A, 7B, and 7C.

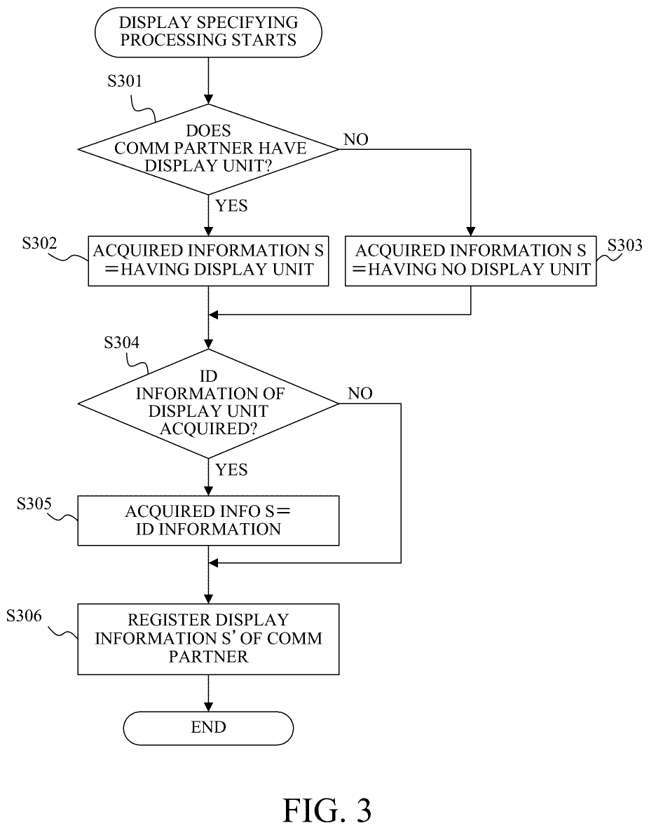

In the imaging system including the lens apparatus 100, the L display specifying unit 104 performs display specifying processing that specifies display information such as the presence or absence of the display unit of each device and the display ability of the display unit based on the ID information on each device input from the L communication unit 101. The specified display information is handled by the L display specifying unit 104, the L display content determining unit 105, and the L display information creating unit 106. A detailed processing flow of the display specifying processing will be described below with reference to FIG. 3.

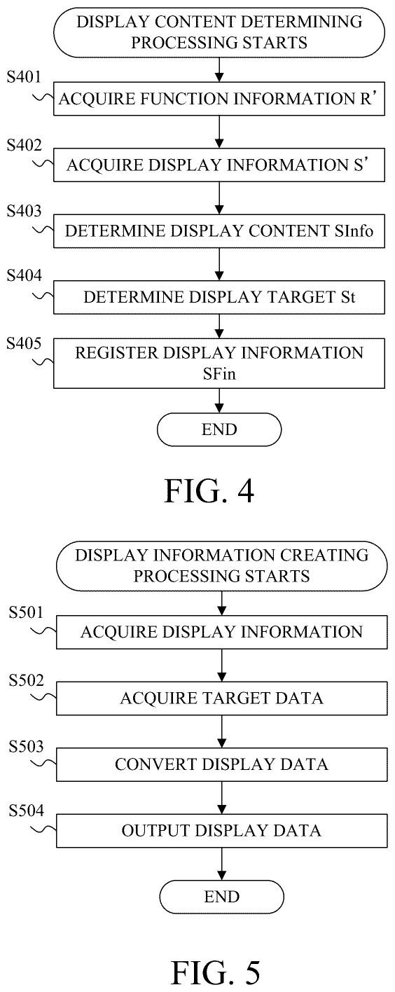

The L display content determining unit 105 has a function of determining what to display on which display unit in the imaging system 10 based on the function information specified by the L function specifying unit 103 and the display information specified by the L display specifying unit 104. More specifically, display content determining processing is performed which determines the content to be displayed on the target external UI and the own UI (L display unit 107). The determined display content information is handled by the L display information creating unit 106. A detailed processing flow of the display content determining processing will be described below with reference to FIG. 4.

The L display information creating unit 106 performs display information creating processing for creating display data to be displayed on the external UI based on the function information specified by the L function specifying unit 103, the display information specified by the L display specifying unit 104, or the display content information determined by the L display content determining unit 105. That is, the L display information creating unit 106 creates display data based on information on at least one of the function and performance of the display apparatus corresponding to the specifying information. The display data is data such as a character string that is actually displayed on the display unit. The L display information creating unit 106 creates, for example, C display data to be displayed on the camera apparatus 200 and D display data to be displayed on the operation apparatus 300, and outputs them to the L communication unit 101. A detailed processing flow of the display information creating processing will be described below with reference to FIG. 5. The L display information creating unit 106 creates not only display data for the external UI but also L display data to be displayed on the L display unit 107, which will be described below. The created L display data is output to the L display unit 107.

The L display unit 107 is a display device, and is a UI that can be at least visually recognized by a user, and displays the L display data input from the L calculator 102. The display device includes LCD, organic EL, or the like, but is not limited to these examples. In this embodiment, the lens apparatus 100 may not have the L display unit 107.

A description will now be given of the camera apparatus 200. The camera apparatus 200 is an image pickup apparatus having an imaging unit, a C communication unit 201, a C calculator 202, and a C display unit 207. The C communication unit 201 is a communication device that communicates with another communicably connected device such as the lens apparatus 100. The C communication unit 201 transmits the data input from the C calculator 202 to the other communicably connected device and outputs the received data from the other communicably connected device to the C calculator 202. In this embodiment, the C communication unit 201 outputs at least the C display data received from the lens apparatus 100 to the C calculator 202. The C communication unit 201 also outputs the ID information input from the C calculator 202 to the lens apparatus 100.

The C calculator 202 is a control unit such as a CPU, and has at least a C display information creating unit 206. The C calculator 202 outputs the C display data input from the C communication unit 201 to the C display unit 207 and outputs its ID information to the C communication unit 201. The C display information creating unit 206 converts the C display data input from the C communication unit 201 into display data in accordance with the display format of the C display unit 207 and outputs the display data to the C display unit 207. The C display unit 207 is a display device and is a UI that can be at least visually recognized by the user, such as a camera VF. The C display unit 207 displays the display data converted by the C display information creating unit 206. The display device includes LCD, organic EL, or the like, but is not limited to these examples.

A description will now be given of the operation apparatus 300. The operation apparatus 300 is an apparatus for operating the lens apparatus 100 and is used, for example, to operate a zoom lens and a focus lens (not illustrated) in the lens apparatus 100. The operation apparatus 300 includes a D communication unit 301, a D calculator 302, and a D display unit 307. In this embodiment, the operation apparatus 300 is an operation apparatus that can operate the focus lens in the lens apparatus 100, but is not limited to this example, and may be an operation apparatus that can operate other members such as the zoom lens.

The D communication unit 301 is a communication device that communicates with another communicably connected device such as the lens apparatus 100. The D communication unit 301 transmits data input from the D calculator 302 to the other communicably connected device, and outputs received data from the other communicably connected device to the D calculator 302. In this embodiment, the D communication unit 301 outputs at least the D display data received from the lens apparatus 100 to the D calculator 302. The D communication unit 301 also outputs the ID information input from the D calculator 302 to the lens apparatus 100.

The D calculator 302 is a control unit such as a CPU. The D calculator 302 outputs the D display data input from the D communication unit 301 to the D display unit 307 and outputs its ID information to the D communication unit 301. The D calculator 302 has a D display information creating unit 306 and converts data into display data having a format suitable for a D display unit 307, which will be described below. The D display unit 307 is a display device and is a UI that can be at least visually recognized by the user. The D display unit 307 displays the display data converted by the D display information creating unit 306. The display device includes LCD, organic EL, or the like, but is not limited to these examples.

Referring now to FIG. 2, a description will be given of function specifying processing performed by the L function specifying unit 103 in the lens apparatus 100 according to this embodiment. FIG. 2 is a flowchart illustrating the function specifying processing. After the lens apparatus 100 is powered on and the lens apparatus 100 is communicably connected to the camera apparatus 200 or the operation apparatus 300, the flow proceeds to step S201. Although FIG. 2 illustrates the lens apparatus 100 communicably connected to the camera apparatus 200, this embodiment is not limited to this example.

First, in step S201, the L function specifying unit 103 determines whether or not the installation location of the communication partner (camera apparatus 200) has been specified. In a case where the installation location of the communication partner can be specified, the flow proceeds to step S202. On the other hand, in a case where the installation location cannot be specified, the flow proceeds to step S203. The installation location is, for example, the distance between the lens apparatus 100 and the camera apparatus 200, the form of connection such as wired or wireless, and the like. However, this embodiment is not limited to this example, and any information that indicates the relationship with the lens apparatus 100 in the imaging system 10 may be used.

In step S202, the L function specifying unit 103 stores the installation location information specified in step S201 as acquired information Rc, and the flow proceeds to step S203. In step S203, the L function specifying unit 103 determines whether ID information has been received from the communication partner (camera apparatus 200). In a case where the L function specifying unit 103 receives the ID information, the flow proceeds to step S204. On the other hand, in a case where the L function specifying unit 103 has not received the ID information, the flow proceeds to step S205. The ID information is ID information on the camera apparatus 200 or ID information on the operation apparatus 300, and may include information about a type of an apparatus communicably connected to the lens apparatus 100, communication format, etc. (information about the performance of the apparatus).

In step S204, the L function specifying unit 103 stores the ID information received in step S203 as acquired information R (Rc), and the flow proceeds to step S205. In step S205, the L function specifying unit 103 specifies the function of the communication partner (camera apparatus 200) based on the acquired information Rc. The details of the function to be specified will be described below with reference to FIGS. 7A, 7B, and 7C but, for example, it is information about a “main photographer.” The function of the UI may be specified as “imaging support.” In this embodiment, the specified function is assumed to be the “main photographer” (or “angle-of-field adjuster”).

Next, in step S206, the L function specifying unit 103 registers the function information R′ (Rc′) specified in step S205 and terminates the function specifying processing. The L function specifying unit 103 performs the processing for the operation apparatus 300 according to the flow of steps S201 to S206 described above, but may store acquired information Rd different from the acquired information Rc as acquired information R and register the acquired information Rd.

Referring now to FIG. 3, a description will be given of the display specifying processing performed by the L display specifying unit 104 in the lens apparatus 100 according to this embodiment. FIG. 3 is a flowchart illustrating the display specifying processing. First, in a case where the function information on the communication partner is specified in the function specifying process described with reference to FIG. 2, the flow proceeds to step S301. Although FIG. 3 illustrates a case where the lens apparatus 100 is connected to the camera apparatus 200 for communication, this embodiment is not limited to this example.

In step S301, the L display specifying unit 104 determines whether or not the communication partner (camera apparatus 200) has a display unit. In a case where the L display specifying unit 104 determines that it has the display unit, the flow proceeds to step S302. On the other hand, in a case where the L display specifying unit 104 determines that it has no display unit, the flow proceeds to step S303. In a case where the communication information from the communication partner or information from product information can be acquired, the L display specifying unit 104 makes a determination based on the acquired information. On the other hand, in a case where the communication information from the communication partner or information from product information cannot be acquired, the L display specifying unit 104 may make a determination based on a preset condition or settings.

In step S302, the L display specifying unit 104 stores information indicating that the communication partner has a display unit as acquired information S(Sc), and the flow proceeds to step S304. In step S303, the L display specifying unit 104 stores information indicating that the communication partner does not have a display unit as acquired information Sc, and the flow proceeds to step S304.

In step S304, the L display specifying unit 104 determines whether or not the ID information on the display unit has been acquired. In a case where it is determined that the ID information on the display unit has been acquired, the flow proceeds to step S305. On the other hand, in a case where it is determined that the ID information on the display unit has not been acquired, the flow proceeds to step S306. Details of the ID information on the display unit (display ID information) will be described below with reference to FIGS. 7A, 7B, and 7C, but for example, it is identifiable information such as “whether or not it is color display,” “the number of display characters,” or the application such as “video display.”

In step S305, the L display specifying unit 104 stores the ID information on the display unit as acquired information Sc, and the flow proceeds to step S306. In step S306, the L display specifying unit 104 registers the acquired information S(Sc) in display information S′(Sc′) tagged with the communication partner, and ends the display specifying processing. For the operation apparatus 300, the L display specifying unit 104 performs processing according to the flow of steps S301 to S306 described above, but may store acquired information Sd different from acquired information Sc as acquired information S, and register display information S′(Sd′).

Referring now to FIG. 4, a description will be given of display content determining processing performed by the L display content determining unit 105 in the lens apparatus 100 according to this embodiment. FIG. 4 is a flowchart illustrating the display content determining processing. In FIG. 4, the lens apparatus 100 determines the contents of the C display data to be transmitted to the camera apparatus 200, but this embodiment is not limited to this example.

First, after the function specifying processing in FIG. 3 and the display specifying processing in FIG. 4 are completed and a display request is made, the flow proceeds to step S401. In step S401, the L display content determining unit 105 acquires function information R′ (Rc′) registered in the function specifying processing. Next, in step S402, the L display content determining unit 105 acquires the display information S′ (Sc′) registered in the display specifying processing. Next, in step S403, the L display content determining unit 105 determines display content SInfo (SInfo_c). In this embodiment, the L display content determining unit 105 monitors the communication data between the lens apparatus 100 and the camera apparatus 200 and sets information that is not actually communicated as the display content SInfo_c.

Next, in step S404, the L display content determining unit 105 determines a display target St (St_c) for displaying the display content SInfo (SInfo_c), and the flow proceeds to step S405. Next, in step S405, the L display content determining unit 105 registers the display information SFin (SFin_c) and ends the display content determining processing.

The L display content determining unit 105 performs processing for the operation apparatus 300 according to the flow of steps S401 to S405 described above. However, the L display content determining unit 105 determines the display content SInfo_d as the display content SInfo in step S403, determines the display target St_d as the display target St in step S404, and registers the display information SFin_d as the display information SFin in step S405. For example, the display information SFin_d registered for the operation apparatus 300 can be registered separately from the display information SFin_c registered for the camera apparatus 200, and the actual information may be the same based on the determined information.

Referring now to FIG. 5, a description will be given of display information creating processing performed by the L display information creating unit 106 in the lens apparatus 100 according to this embodiment. FIG. 5 is a flowchart illustrating the display information creating processing. Although FIG. 5 illustrates the lens apparatus 100 that creates C display data to be transmitted to the camera apparatus 200, this embodiment is not limited to this example.

First, after the display content determining processing in FIG. 4 is completed and a display information creation request is made, the flow proceeds to step S501. In step S501, the L display information creating unit 106 acquires the display information SFin_c determined in the display content determining processing. Next, in step S502, the L display information creating unit 106 acquires the target data (display target St_c) determined in the display content determining processing based on the display information SFin_c.

Next, in step S503, the L display information creating unit 106 creates C display data that is made by converting the target data into a displayable format based on the display information SFin_c acquired in step S501 and the target data (display target St_c) acquired in step S502. In this embodiment, the C display data is ASCII data, but is not limited to this example. For example, in a case where the display device is the same as the lens apparatus 100, it may be converted into output data suitable for the display device. In a case where information on the number of display pixels can be acquired, information such as turning on and turning off each display pixel may be output.

Next, in step S504, the L display information creating unit 106 outputs the C display data created in step S503 to the L communication unit 101, and ends the display information creating processing. The L display information creating unit 106 performs processing for the operation apparatus 300 according to the flow of steps S501 to S504 described above. The D display data can be created in step S503, and the D display data can be output to the L communication unit 101 in step S504.

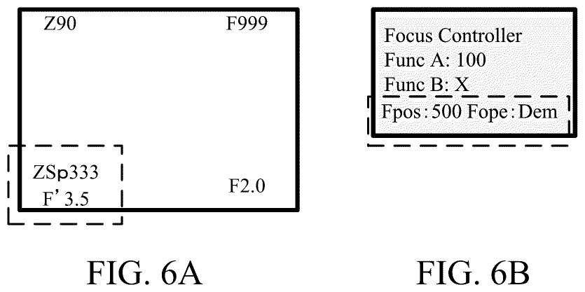

The camera apparatus 200 displays the C display data received from the lens apparatus 100 on the C display unit 207. The operation apparatus 300 displays the D display data received from the lens apparatus 100 on the D display unit 307. The actual display by this processing will be described below with reference to FIGS. 6A and 6B.

Referring now to FIGS. 6A and 6B, a description will be given of an example of the UI displayed on the external UI according to this embodiment. FIG. 6A is an example of the UI displayed on the C display unit 207, and FIG. 6B is an example of the UI displayed on the D display unit 307. A dotted line indicates the C display data in FIG. 6A and the D display data in FIG. 6B, and it is given for description purposes and is not actually displayed. In this embodiment, as illustrated in FIGS. 6A and 6B, information within the dotted line is provided. The C display data displays necessary information for the “main photographer” or the “angle-of-field adjuster,” such as zoom speed information and effective value. The display data is limited to two lines so as not to hinder the video display confirmation. The D display data displays information necessary for the “focus operator,” such as focus position information and focus operation authority information.

Referring now to FIGS. 7A, 7B, and 7C, a description will be given of an example of function and display specification according to this embodiment. FIG. 7A is an example of function. FIG. 7B is an example of display specification. FIG. 7C illustrates locations in the imaging system 10. The imaging system 10 illustrated in FIG. 7C is an example. A shaded portion in FIG. 7C indicates a display unit.

FIG. 7A is a table that associates locations of photographers with specified functions. The “location” in the table indicates the location of the photographer or the operator. For example, it is a location where the camera apparatus 200 or the lens apparatus 100 can actually be operated, a location where only a specific operation apparatus 300 can be operated, and a location distant from the camera apparatus 200 or the lens apparatus 100, such as a VE or switcher. FIG. 7C illustrates the locations of photographers or operators by P1 to P3. However, this embodiment is not limited to this example and may be subdivided based on information such as the connection form (wired or wireless) with the camera apparatus 200, which is the main imaging device, and a distance.

The function is the function in the imaging system 10 of the photographer or operator at the location described above. For example, the function indicates a “main photographer,” “angle-of-view adjustment,” “focus operation,” “monitoring,” and “system monitoring.” However, this embodiment is not limited to these examples. Since the function is different depending on the imaging mode, it may be registered. In order to display the information for supporting the operation of each function (information for operation support or remote operation support, etc.), the information that can support the specified function is acquired from the information storing apparatus. For example, for the “main photographer,” the information includes lens position information as the “imaging support” information, and for the “system monitoring,” the information includes communication statuses of a plurality of image pickup apparatuses and devices, etc.

FIG. 7B is a table in which display units are associated with display capabilities and applications of specified display units. The “display unit” in the table is a UI that can be displayed within the imaging system 10. For example, it is a camera VF and lens, accessories such as operation apparatus, a VE (video engineering) system, and a dedicated display apparatus. FIG. 7C illustrates display units D1 to D3. D1′ indicates a viewfinder that the photographer actually looks through, and may be displayed in the same manner as D1, or the display content may be displayed separately. This embodiment is not limited to this example as long as it is an apparatus that can be identified by communication.

Next follows a description of the specified display ability and application. The display ability includes a displayable range (number of lines and characters), size, black and white or color, and the like. This information may be predetermined or may be identified by communication. It may also determine whether the ability of the information storing apparatus is higher or lower than, or equal to that of its display unit. Information may be included as to whether or not the display can be visually recognized by the photographer during imaging.

The display application indicates display only or video superimposition. Even in a case where the above display ability is high, it is difficult to display a large amount of information in a case where video display is the main purpose and support information is superimposed on the video. Thus, the display content may be determined in consideration of the application. Correspondence tables such as those illustrated in FIGS. 7A and 7B may be stored, for example, in the L calculator 102 or an unillustrated nonvolatile memory, or the logic and priority for specifying functions and displays can be changed by setting.

Since the above configuration can specify the function and display unit of the communicably connected device and determine the content to be displayed on the external UI based on the specified information, the display on the external UI is always necessary information for a viewer of the UI. Even if the communication data between the camera apparatus 200 and the lens apparatus 100 are changed, the display content is determined by viewing the communication data, so the change in the communication data is reflected in the display of the external UI. Even if the display ability of the display unit in the operation apparatus 300 is changed, as long as the information on the display unit can be identified, the display of the external UI can be changed according to the display ability. The above processing can display on the external UI information corresponding to the function of the communicably connected device and the display unit. This embodiment illustrates the example illustrated in FIG. 7A for the function information, but the function information is not limited to this example.

Regarding the display information, this embodiment uses ID information such as the presence or absence of a display unit and display ability, but this embodiment is not limited to this example. For example, the display information may be information such as whether or not transmission and reception of the C display data are supported, or setting information for the display unit of each device. If the setting information for the display unit can be acquired, display may be possible depending on the setting, but the display information output from the lens apparatus 100 can be changed depending on whether or not it is actually displayed.

In the display content determining processing, this embodiment monitors the communication information with the communication partner, and uses information that is not actually communicated as the display content, but this embodiment is not limited to this example. For example, information such as an abnormal state may be information that the user wants to recognize, even if it overlaps the screen, and the display content may be determined in consideration of the display settings described above.

This embodiment automatically determines specification of the function and display unit based on the information acquired from each device, but this embodiment is not limited to this example. For example, this embodiment may set the function or the display unit itself, or the priority order for determining the display content.

This embodiment sets the trigger for starting the function specifying processing, the display specifying processing, the display content determining processing, and the display information creating processing to a communication connection with another communicably connected device, but the trigger is limited to this example. For example, the trigger may be a switch operation within the imaging system, or at least one processing may not be performed in conjunction. This embodiment always displays the C display data, but is not limited to this example. For example, the C display data may be displayed only while a switch to which the additional information display function is assigned is operated.

This embodiment mainly outputs the display information created by the display information creating processing to the external UI, but its L display unit 107 may be the target. In this embodiment, the lens apparatus 100 performs the function specifying processing, display specifying processing, display content determining processing, and display information creating processing, but this embodiment is not limited to this example. At least part of the above processing may be performed by the camera apparatus 200 or the operation apparatus 300.

As described above, the lens apparatus 100 according to this embodiment is a control apparatus communicable with the unit (camera apparatus 200, operation apparatus 300) including the display apparatus in the imaging system 10. The lens apparatus 100 has a communication device (L communication unit 101), an information specifying unit (L function specifying unit 103, L display specifying unit 104), and a display content determining unit (L display content determining unit 105). The communication device communicates with the display apparatus. The information specifying unit specifies specifying information about the display apparatus in the imaging system 10 through communication. The display content determining unit determines display information to be displayed on the display apparatus based on the specifying information. The communication device transmits display data created based on the display information to the display apparatus. The specifying information may include function information (for example, zoom operation) of the display apparatus in the imaging system 10 and display specifying information on the display unit provided in the display apparatus (apparatus for displaying information necessary for the function, information specifying the display location (such as camera VF)). The information specifying unit may include a function specifying unit (L function specifying unit 103) that specifies function information, and a display specifying unit (L display specifying unit 104) that specifies display specifying information.

This embodiment can display information necessary for the optimum location for the photographer according to the function of the photographer.

### Example 2

Referring now to FIGS. 2 to 5 and 7 to 9, a description will be given of an imaging system 10a according to a second embodiment. Those elements in this embodiment, which are corresponding elements in the first embodiment, will be designated by the same reference numerals, and a description thereof will be omitted.

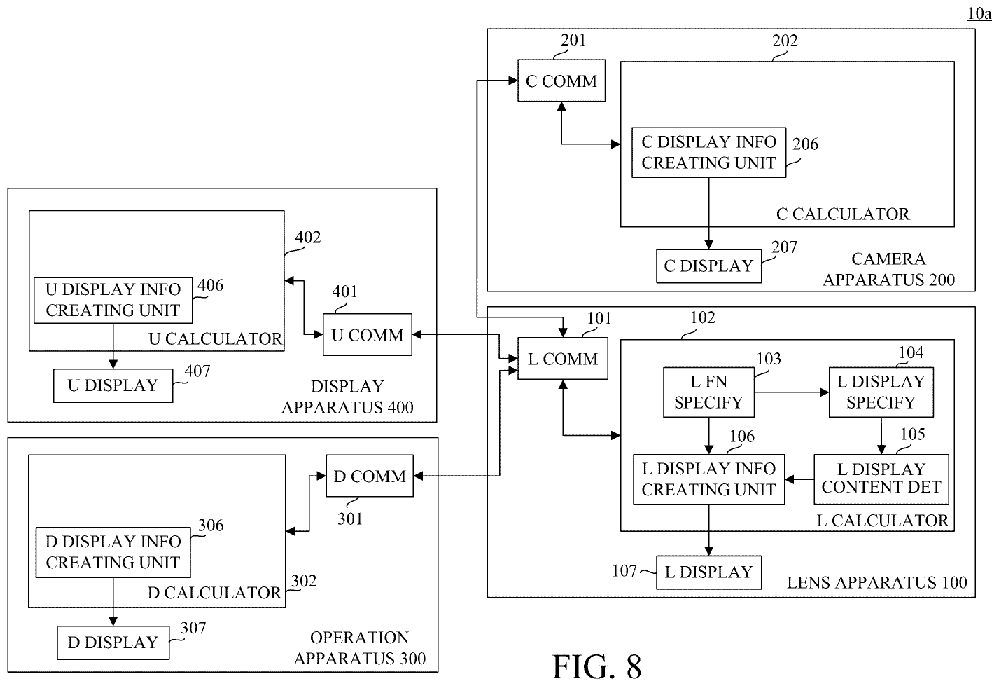

Referring now to FIG. 8, a description will be given of the configuration of the imaging system 10a. FIG. 8 is a block diagram of the imaging system 10a. In the first embodiment, in addition to the lens apparatus 100, an example uses lens accessories such as the camera apparatus 200 and the operation apparatus 300, which are indispensable for imaging. The general display specifications of the camera apparatus 200 and the operation apparatus 300 have already been determined to some extent, and necessary display information from the lens apparatus 100 may be added. It is also conceivable to use a display dedicated apparatus such as a tablet for the imaging environment. In such a case, the display dedicated apparatus may be effectively used to make imaging more efficient. This embodiment illustrates an example that uses the display dedicated apparatus as the external UI.

A display apparatus (display dedicated apparatus) 400 such as a monitor is added to the imaging system 10a illustrated in FIG. 8, in comparison with the imaging system 10 of FIG. 1. In this embodiment, the lens apparatus 100 is an information storing apparatus (control apparatus), and the camera apparatus 200, operation apparatus 300, and display apparatus 400 are external UIs (units including the display apparatus).

A description will now be given of the lens apparatus 100. The configuration of the lens apparatus 100 is similar to the lens apparatus 100 described with reference to FIG. 1. This embodiment is similar to the first embodiment in using FIGS. 2 to 4 for the function specifying processing performed by the L function specifying unit 103, the display specifying processing performed by the L display specifying unit 104, and the display content determining processing performed by the L display content determining unit 105. The display information creating processing by the L display information creating unit 106 according to this embodiment will be described with reference to FIG. 5 similarly to the first embodiment, but the display information creating processing according to this embodiment creates U display data to be displayed on the display apparatus 400 and outputs it to the L communication unit 101 in addition to the processing in the first embodiment.

A description will now be given of the display apparatus 400. The display apparatus 400 is a communicably connected apparatus that can display character strings and videos. The display apparatus 400 includes a U communication unit 401, a U calculator 402, and a U display unit 407. In this embodiment, the display apparatus 400 is a tablet such as a smartphone, but is not limited to this example.

The U communication unit 401 is a communication device that communicates with another communicably connected device such as the lens apparatus 100. The U communication unit 401 transmits the data input from the U calculator 402 to the other communicably connected device, and outputs the reception data from the other communicably connected device to the U calculator 402. In this embodiment, at least the U display data received from the lens apparatus 100 is output to the U calculator 402. The ID information input from the U calculator 402 is output to the lens apparatus 100. The U calculator 402 is a control unit such as a CPU. The U display data input from U communication unit 401 is output to the U display unit 407 and its ID information is output to the U communication unit 401. It constitutes a U display information creating unit 406, and converts it into display data suitable for a U display unit 407, which will be described below. The U display unit 407 is a display device and is a UI that can be at least visually recognized by the user, and displays the display data converted by the U display information creating unit 406. The display device includes LCD, organic EL, or the like, but is not limited to these examples.

A description will now be given of function specifying processing according to this embodiment. Using the flowchart of FIG. 2, the functions of camera apparatus 200 and operation apparatus 300 are the same as those of the first embodiment. A description will now be given of specifying the function of the display apparatus 400 in comparison with the first embodiment.

In steps S202 and S204, information is stored in the acquired information Ru, and in step S205, the function of the display apparatus 400 is specified based on the acquired information Ru. The function specified in this embodiment is, for example, “additional information display” and “status display” in FIGS. 7A, 7B, and 7C. It is a device that is not essential for the conventional imaging device, and it is a function of a display apparatus for checking the status to be added to improve the imaging efficiency. In step S206, the function information Ru′ is registered, and the flow ends.

A description will now be given of the display specifying processing according to this embodiment. Using the flowchart of FIG. 3, the display information on the camera apparatus 200 and the operation apparatus 300 is similar to that of the first embodiment. A description will now be given of specifying the display information on the display apparatus 400 in comparison with the first embodiment.

In steps S302, S303, and S305, information is stored in the acquired information Su. In step S306, the display information Su′ on the display apparatus 400 is registered based on the acquired information Su. The display information specified in this embodiment is, for example, a “display dedicated apparatus” in FIGS. 7A, 7B, and 7C. Although the table illustrates “dependence on acquired result,” it also depends on the display application in the tablet and the screen size and resolution of the tablet itself. If such information about display can be acquired, the display content becomes more suitable for the display unit.

A description will now be given of the display content determining processing according to this embodiment. Using the flowchart of FIG. 4, the display contents of the camera apparatus 200 and the operation apparatus 300 are similar to those of the first embodiment. A description will now be given of determining the display content of the display apparatus 400 in comparison with the first embodiment.

The function information Ru′ is acquired in step S401, and the display information Su′ is acquired in step S402. In step S403, the display content SInfo_u is determined. This embodiment sets the information about the state of the lens apparatus 100 to the display content SInfo_u. In step S404, display target St_u is determined, and in step S405, display information SFin_u is registered, and the flow ends.

The display information creating processing is similar to that of the first embodiment, except that the display apparatus 400 creates the U display data based on the display information SFin_u and outputs the created U display data to the L communication unit 101.

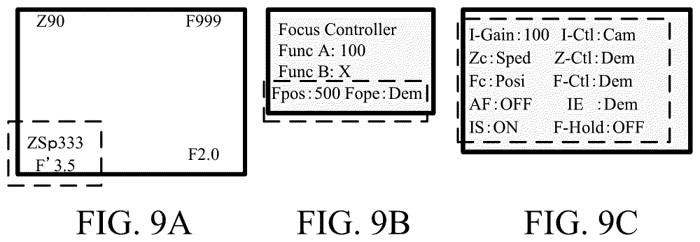

Referring now to FIGS. 9A, 9B, and 9C, a description will be given of an example of the UI displayed on the external UI according to this embodiment. FIGS. 9A, 9B, and 9C are examples of UIs displayed on the external UI. In comparison with FIGS. 6A and 6B in the first embodiment, FIG. 9A is similar to FIG. 6A and FIG. 9B is similar to FIG. 6B, and the only difference from FIGS. 6A and 6B is that FIG. 9C is added. FIG. 9C illustrates an example of the U display unit 407.

A dotted line in FIG. 9C indicates the U display unit 407, which is added for description convenience and is not actually displayed. In this embodiment, as illustrated in FIG. 9C, all data displayed on the U display unit 407 are U display data. The U display data display information necessary for the “status display” as “additional information display,” and as an example, indicates the enabled and disabled status of the function and a command operation source. In addition, as a display unit that does not display videos, the example uses the entire display area only for the above “status display.”

The above processing can display information according to the function of the device and the display unit on the external UI, even if the display dedicated apparatus, which was not available in conventional imaging systems, becomes an external UI. In this embodiment, the L display unit 107 is not necessarily required, and the status of the lens apparatus 100 can be confirmed on the display apparatus 400 even if the L display unit 107 is not provided. This embodiment sets the function of the display apparatus 400, which is a dedicated display apparatus, to display additional information and display the status, but this embodiment is not limited to this example. Depending on the display application and the device, some tablets do not have high display ability, so the display content may be determined to be the optimum display content according to the acquired display information. For example, all status information may be displayed in a list manner, or if the display area is limited, display characters may be scrolled and displayed.

Similarly to the first embodiment, this embodiment may monitor the content of communication with the camera apparatus 200 or the operation apparatus 300, the communication frequency, the display frequency, or the like, and reflect the monitored information in the display of the display apparatus 400. The first embodiment outputs the information not included in the communication contents with the camera apparatus 200 to the camera apparatus 200 as C display data, but for example, this embodiment may make the display apparatus 400 for display only display information that has not been transmitted to the camera apparatus 200 or the operation apparatus 300.

This embodiment communicably connects the display apparatus 400 with the lens apparatus 100, but is not limited to this example and the display apparatus 400 may be communicably connected, for example, to the camera apparatus 200 and the operation apparatus 300. The D display data transmitted from the lens apparatus 100 may be transmitted from the operation apparatus 300 to the display apparatus 400 and the D display data may be displayed on the U display unit 407. Thereby, the operator of the operation apparatus 300 that does not constitute the D display unit 307 can confirm necessary information.

This embodiment can display information necessary for the optimum location for the photographer according to the function of the photographer.

### Third Embodiment

Referring now to FIGS. 5, 7A, 7B, 7C, and 10 to 14D, a description will be given of an imaging system 10b according to a third embodiment. Those elements in this embodiment, which are corresponding elements in the first and second embodiments, will be designated by the same reference numerals, and a description thereof will be omitted. The first and second embodiments set the external UI to a device directly communicably connected to the lens apparatus 100, which is an information storing apparatus, but in fact, in addition to directly communicably connected devices, some imaging systems use devices via some devices as an external UIs. For example, the VE system 500 is communicably connected with one or more cameras and is not directly communicably connected with lens apparatus 100. The VE has a video adjusting function, and may actually perform operations such as fine adjustment of focusing, and requires information different from that of the camera apparatus 200.

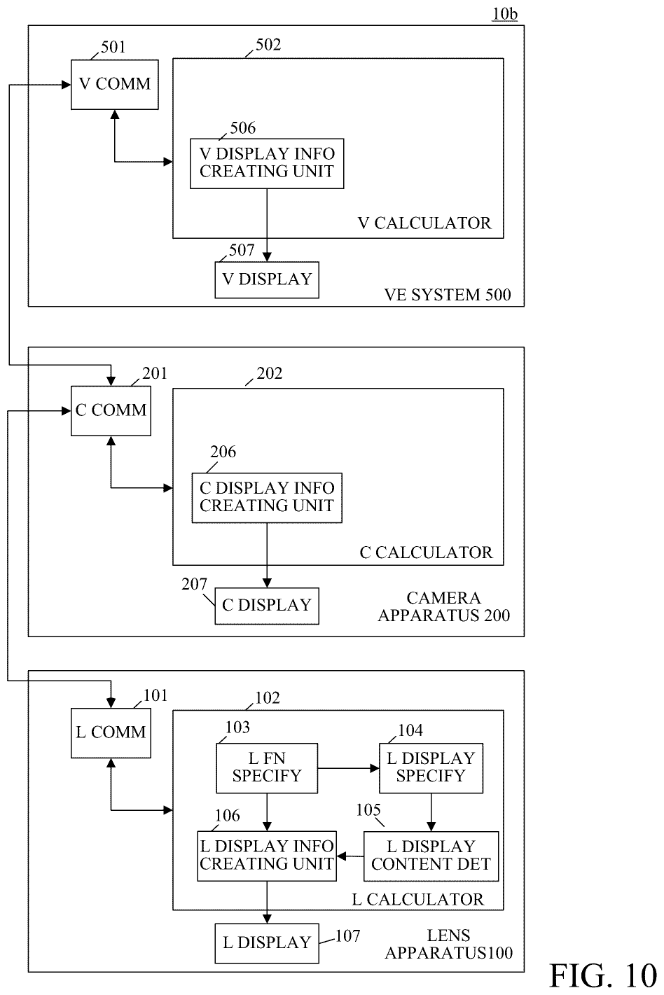

Referring now to FIG. 10, a description will be given of the configuration of the imaging system 10b. FIG. 10 is a block diagram of the imaging system 10b. In comparison with the imaging system 10 of FIG. 1, the imaging system 10b omits the operation apparatus 300 and includes the VE system 500. In this embodiment, the lens apparatus 100 serves as an information storing apparatus (control apparatus), and the camera apparatus 200 and VE system 500 serve as external UIs (units including a display apparatus). The camera apparatus 200 is directly communicably connected with the lens apparatus 100 similarly to the first and second embodiments. On the other hand, the VE system 500 is directly connected to the camera apparatus 200 instead of the lens apparatus 100.

A description will be given of the lens apparatus 100. The configuration of the lens apparatus 100 is similar to that of the lens apparatus 100 described with reference to FIG. 1. The L display information creating unit 106 uses FIG. 5 for the display information creating processing as in the first embodiment, but is different in further creating V display data to be displayed on the VE system 500 and outputting it to the L communication unit 101.

In this embodiment, the L communication unit 101 can determine from the ID information received from the camera apparatus 200 that the VE system 500 is communicably connected with the camera apparatus 200. Both the C display data and the V display data are transmitted to the camera apparatus 200, but the V display data is given ID data A that can be identified as being for the VE system 500.

A description will now be given of the camera apparatus 200. The configuration of the camera apparatus 200 is similar to that of the camera apparatus 200 described with reference to FIG. 1. In a case where the C communication unit 201 communicates with the VE system 500, the C communication unit 201 transmits the ID information received from the VE system 500 to the lens apparatus 100. The C display data received from the lens apparatus 100 is output to the C calculator 202, and the V display data is determined to be data for the VE system 500 based on the attached ID data A, and is transmitted to the VE system 500.

A description will now be given of the VE system 500. The VE system 500 includes a V communication unit 501, a V calculator 502, and a V display unit 507. The V communication unit 501 is a communication device that communicates with another communicably connected device such as the camera apparatus 200. The data input from the V calculator 502 is transmitted to another communicably connected device, and the received data from the other communicably connected device is output to the V calculator 502. This embodiment outputs at least the V display data received from the camera apparatus 200 to the V calculator 502. The ID information input from the V calculator 502 is output to the camera apparatus 200. The V calculator 502 is a control unit such as a CPU, and has at least a V display information creating unit 506. The V calculator 502 outputs the V display data input from the V communication unit 501 to the V display unit 507, and outputs its ID information to the V display data.

The V display information creating unit 506 converts the V display data input from the V communication unit 501 into display data suitable for the display format of the V display unit 507 and outputs the display data to the V display unit 507. The V display unit 507 is a display device, is a UI that can be at least visually recognized by the user, such as a monitor, and displays the display data converted by the V display information creating unit 506. The display device includes LCD, organic EL, or the like, but this embodiment is not limited to these examples.

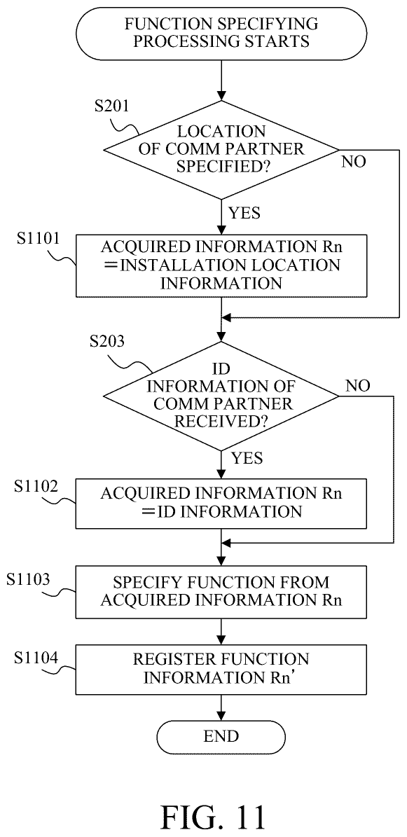

Referring now to FIG. 11, a description will be given of function specifying processing performed by the L function specifying unit 103 according to this embodiment. FIG. 11 is a flowchart illustrating the function specifying processing. First, after the lens apparatus 100 is powered on and communicably connected to the camera apparatus 200 (including the VE system 500), the flow proceeds to step S201. A description will now be given of communicable connection with the VE system 500.

In step S201, the L function specifying unit 103 determines whether or not the installation location of the communication partner (VE system 500) has been specified. In a case where the installation location of the VE system 500 can be specified, the flow proceeds to step S1101. On the other hand, in a case where the installation location of the VE system 500 cannot be specified, the flow proceeds to step S203. The installation location is, for example, a distance between the VE system 500 and the camera apparatus 200, and the connection form such as wired or wireless.

In step S1101, the L function specifying unit 103 stores the installation location information specified in step S201 as acquired information Rn (Rcv), and the flow proceeds to step S203. The acquired information Rcv indicates acquired information on the VE system 500 acquired from the camera apparatus 200.

In step S203, the L function specifying unit 103 determines whether ID information has been received from the communication partner (VE system 500). In a case where the ID information has been received, the flow proceeds to step S1102. On the other hand, in a case where the ID information has not been received, the flow proceeds to step S1103. The ID information is here identifiable information about the VE system 500.

In step S1102, the L function specifying unit 103 stores the ID information in the acquired information Rn (Rcv), and the flow proceeds to step S1103. In step S1103, the L function specifying unit 103 specifies the function of the communication partner (VE system 500) based on the acquired information Rcv. The function to be specified is “VE” (or “VE support”) in this embodiment (see FIGS. 7A, 7B, and 7C). Next, in step S1104, the L function specifying unit 103 registers the function information Rn′ (Rcv′) specified in step S1103, and ends the function specifying processing.

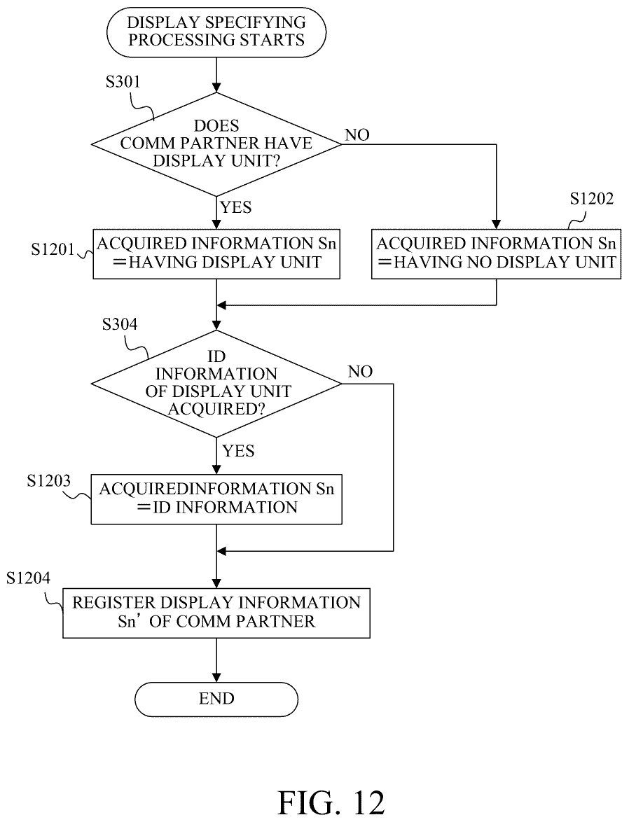

Referring now to FIG. 12, a description will be given of display specifying processing performed by the L display specifying unit 104 according to this embodiment. FIG. 12 is a flowchart illustrating the display specifying processing. First, once the function information on the communication partner is specified in the function specifying processing described with reference to FIG. 11, the flow proceeds to step S301. FIG. 12 illustrates communicable connection with the VE system 500.

In step S301, the L display specifying unit 104 determines whether or not the communication partner (VE system 500) has a display unit. In a case where it is determined that there is a display unit, the flow proceeds to step S1201. On the other hand, in a case where it is determined that there is no display unit, the flow proceeds to step S1202. In practice, the L display specifying unit 104 acquires the information on the VE system 500 from the camera apparatus 200. In a case where the information about the VE system 500 can be obtained from the product information on communication information from the communication partner, the L display specifying unit 104 makes a determination based on the obtained information. On the other hand, in a case where the information about the VE system 500 cannot be obtained from the communication information or product information, it may be determined based on preset conditions and settings. This point is similar to that of FIG. 3.

In step S1201, the L display specifying unit 104 stores the fact that the communication partner has a display unit as acquired information Sn (Scv), and the flow proceeds to step S304. The acquired information Scv indicates acquired information on the VE system 500 acquired from the camera apparatus 200. In step S1202, the L display specifying unit 104 stores in the acquired information Sn (Scv) that the communication partner does not have a display unit, and the flow proceeds to step S304.

In step S304, the L display specifying unit 104 determines whether or not the ID information on the display unit has been acquired. In a case where it is determined that the ID information on the display unit has been acquired, the flow proceeds to step S1203. On the other hand, in a case where it is determined that the ID information on the display unit has not been acquired, the flow proceeds to step S1204. In this embodiment, the specified display is “high display ability” (or “video superimposed”) (see FIGS. 7A, 7B, and 7C).

In step S1203, the L display specifying unit 104 stores the acquired ID information as acquired information Sn (Sc), and the flow proceeds to step S306. In step S1204, the L display specifying unit 104 registers the acquired information Scv as the display information Sn′ (Scv′) associated with the communication partner, and ends the display specifying process.

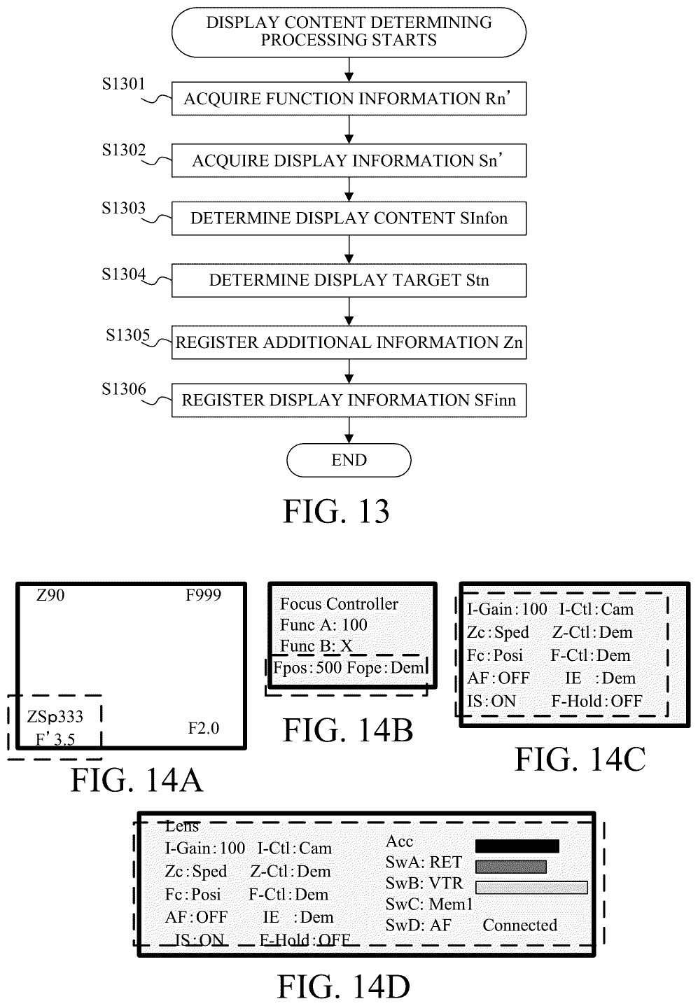

Referring now to FIG. 13, a description will be given of display content determining processing performed by the L display content determining unit 105 according to this embodiment. FIG. 13 is a flowchart illustrating the display content determining processing. FIG. 13 illustrates determining the contents of the V display data to be transmitted to the VE system 500. First, after the function specifying processing in FIG. 11 and the display specifying processing in FIG. 12 are completed and a display request is made, the flow proceeds to step S1301.

In step S1301, the L display content determining unit 105 acquires the function information Rn′ (Rev′) registered in the function specifying processing. Next, in step S1302, the L display content determining unit 105 acquires the display information Sn′ (Scv′) registered in the display specifying processing. Next, in step S1303, the L display content determining unit 105 determines display content Sinfo (SInfo_cv). The display content SInfo_cv indicates the display content of the VE system 500 to be transmitted to the camera apparatus 200.

This embodiment sets information to the display content SInfo_cv, such as VE supporting information, more specifically a focus command value and operation authority information for supporting operation relating to fine adjustment of focusing. This embodiment does not configure the display apparatus 400 described in the second embodiment, and thus sets the status list of the lens apparatus 100 as displayed in the display apparatus 400.

Next, in step S1304, the L display content determining unit 105 determines the display target St cv for displaying the display content SInfo_cv. The display target St cv indicates the VE system 500 of the display target communicating via the camera apparatus 200. Next, in step S1305, the L display content determining unit 105 adds additional information Zn (Zv) indicating that it is for the VE system 500 to the display information SFin_cv including the display content SInfo_cv and the display target St cv. Next, in step S1306, the L display content determining unit 105 registers the display information SFin_cv to which the additional information Zv is added, and ends the display content determining processing. The display information SFin_cv indicates display information on the VE system 500 to be transmitted to the camera apparatus 200. The additional information Zv can identify that the communication data is data for the VE system 500 as well.

Referring now to FIGS. 14A to 14D, a description will be given of an example of the UI displayed on the external UI according to this embodiment. FIG. 14A is an example of the UI displayed on the C display unit 207. FIG. 14D is an example of the UI displayed on the V display unit 507. FIGS. 14B and 14C are the same as FIGS. 9B and 9C described in the second embodiment, respectively, and are illustrated for comparison, but are not illustrated in this example. FIG. 14B illustrates an example of the D display unit 307. FIG. 14C illustrates an example of the U display unit 407.

A dotted line illustrates the C display data in FIG. 14A and the V display data in FIG. 14D is illustrated for description convenience and is not actually illustrated. In this embodiment, information within the dotted line is given as illustrated. The C display data display information necessary for the “main photographer” or “angle-of-field adjuster,” and the display content is similar to that in FIG. 6A of the first embodiment. The V display data display information necessary for “VE.” The contents of the D display data and U display data in FIGS. 14B and 14C illustrated for comparison are included in the V display data. This is because the focus command value and focus operation authority information in the D display data, and the lens status list information in the U display data are not necessary for the “main photographer” but are necessary for the “VE.”

Due to the above processing, not only the device that is directly communicably connected to the information storing apparatus but also the external UI that is not directly communicably connected to the information storing apparatus can display information according to the function of the device and the display unit.

Even in this embodiment, the function information is the same as the information illustrated in FIG. 7A, but this embodiment is not limited to this example. The function of the device in the UI, the function of each UI, or the function of the person viewing the UI may be specified. This embodiment sets the display content to information for supporting the fine adjustment of focusing, but this embodiment is not limited to this example, and for example, information for supporting the operation of adjusting a back focus lens may be displayed.

This embodiment uses one surface of the V display unit 507 for the V display data, but in order to actually display videos, the display range of the V display data may be limited to the displayable area of the V display unit 507. This embodiment sets the function of the VE system 500 to a function that only supports the VE, but for example, information not displayed on the camera apparatus 200 may be displayed to support the photographer. Thus, for example, communication information (communication content, communication frequency, or display frequency) between the lens apparatus 100 and the camera apparatus 200 may be monitored, and the monitoring results may be reflected in the V display data. This embodiment sets the camera apparatus 200 as a device directly communicably connected to the information storing apparatus, and the VE system 500 as a device not directly communicably connected to the information storing apparatus. However, this embodiment is not limited to this example. For example, a device that is directly communicably connected with the information storing apparatus may be set to the operation apparatus 300 described in the first or second embodiment, and a device that is not directly communicably connected with the information storing apparatus may be set to the display apparatus 400 described in the second embodiment.

This embodiment can display information necessary for the optimum location for the photographer according to the function of the photographer.

### Fourth Embodiment

Referring now to FIGS. 5, 7A, 7B, 7C, and 11 to 16, a description will be given of an imaging system 10c according to a fourth embodiment. Those elements in this embodiment, which are corresponding elements in the first to third embodiments, will be designated by the same reference numerals, and a description thereof will be omitted. In the first to third embodiments, the lens apparatus 100, which is an information storing apparatus (control apparatus), has an L function specifying unit 103, an L display specifying unit 104, an L display content determining unit 105, and an L display information creating unit 106. Therefore, the lens apparatus 100 performs the function specifying processing, the display specifying processing, the display content determining processing, and the display information creating processing, but the information storing apparatus does not need to perform all of the above processing. Since there are a variety of types of imaging systems, it may be more efficient to divide the above processing among the communicably connected devices, and to perform the above processing cooperatively among the devices. In addition, this method may be able to display information that matches the functions and display unit.

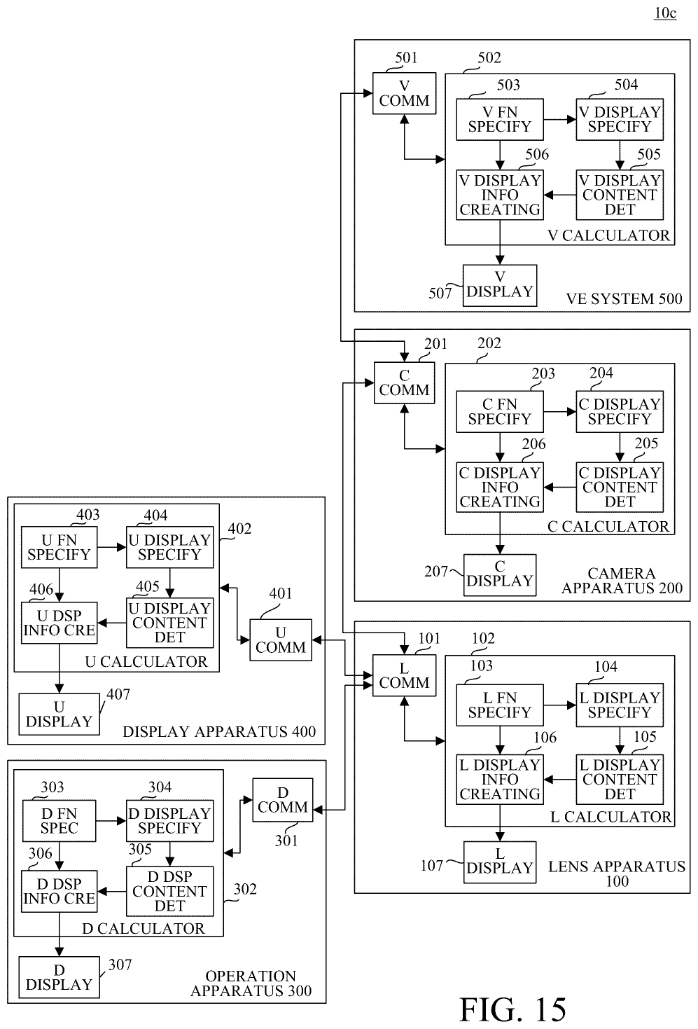

Referring now to FIG. 15, a description will be given of the configuration of the imaging system 10c according to this embodiment. FIG. 15 is a block diagram of the imaging system 10c. The imaging system 10c is different from the imaging system 10a of FIG. 8 in that a VE system 500 is added and a function specifying unit, a display specifying unit, and a display content determining unit are added to the camera apparatus 200 and the VE system 500.

A description will now be given of the camera apparatus 200. The camera apparatus 200 includes a C function specifying unit 203 as a function specifying unit, a C display specifying unit 204 as a display specifying unit, and a C display content determining unit 205 as a display content determining unit. These units perform similar processing to that of the L function specifying unit 103, the L display specifying unit 104, and the L display content determining unit 105, respectively.

A description will now be given of the operation apparatus 300. The operation apparatus 300 includes a D function specifying unit 303 as a function specifying unit, a D display specifying unit 304 as a display specifying unit, and a D display content determining unit 305 as a display content determining unit. These units perform similar processing to that of the L function specifying unit 103, the L display specifying unit 104, and the L display content determining unit 105, respectively.

A description will now be given of the display apparatus 400. The display apparatus 400 includes a U function specifying unit 403 as a function specifying unit, a U display specifying unit 404 as a display specifying unit, and a U display content determining unit 405 as a display content determining unit. These units perform similar processing to that of the L function specifying unit 103, the L display specifying unit 104, and the L display content determining unit 105, respectively.

A description will now be given of the VE system 500. The VE system 500 includes a V function specifying unit 503 as a function specifying unit, a V display specifying unit 504 as a display specifying unit, and a V display content determining unit 505 as a display content determining unit. These units perform similar processing to that of the L function specifying unit 103, the L display specifying unit 104, and the L display content determining unit 105, respectively.

This embodiment can more efficiently display information according to the function of each device and the display unit, especially in an imaging system that includes a plurality of communicably connected devices.

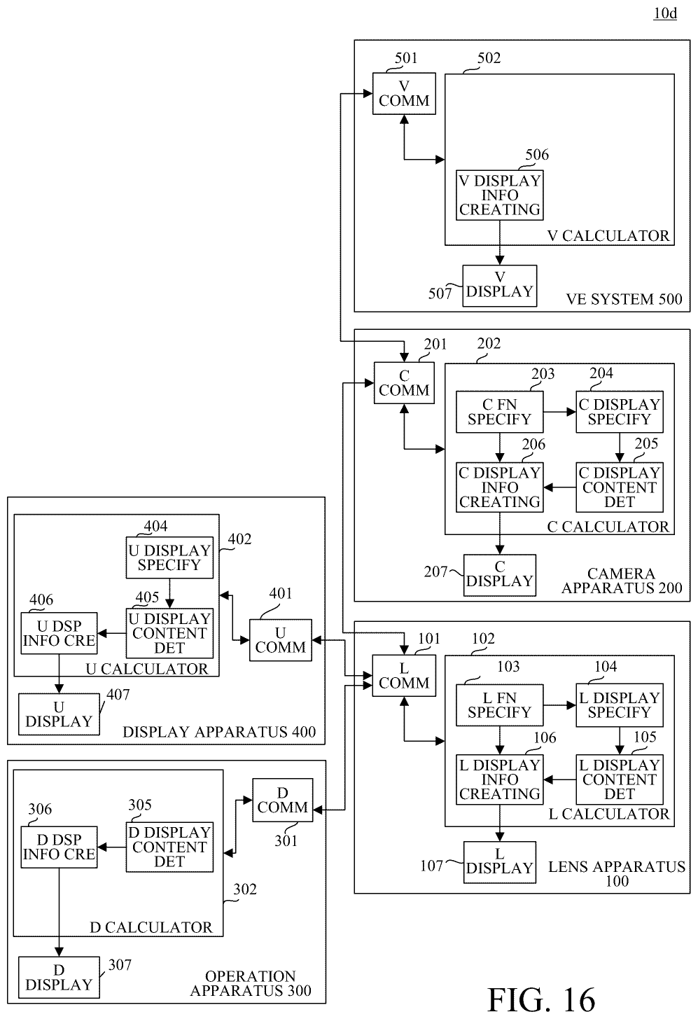

In this embodiment, all devices have a function specifying unit, a display specifying unit, and a display content determining unit, but the embodiment is not limited to this example. For example, only the lens apparatus 100 and the camera apparatus 200 may have function specifying units. In particular, the VE system 500 has a strong affinity with the camera apparatus 200, and the operation apparatus 300 has a strong affinity with the lens apparatus 100. Therefore, in a case where the lens apparatus 100 and the camera apparatus 200 collectively send and receive ID information to and from devices that have a strong affinity, a function to be specified, the display unit, and the display content to be determined will be highly accurate information. An example will be described with reference to FIG. 16.

FIG. 16 is a block diagram of an imaging system 10d as a variation of this embodiment. The imaging system 10d in FIG. 16 has a configuration in which some elements are removed from the imaging system 10c of FIG. 15. The lens apparatus 100 and the camera apparatus 200 have the same configurations as those of FIG. 15, but the operation apparatus 300, the display apparatus 400, and the VE system 500 have different configurations. Specific differences will be briefly described below.

The operation apparatus 300 in FIG. 16 does not have the D function specifying unit 303 or the D display specifying unit 304 in FIG. 15. That is, the operation apparatus 300 in FIG. 16 does not specify the function or the display unit, and determines the display content to be displayed on its display unit based on the display data from the lens apparatus 100 with high affinity, and displays the determined display content.

The display apparatus 400 in FIG. 16 does not have the U function specifying unit 403 in FIG. 15 and does not specify a function. As an example, based on the display data from the lens apparatus 100, the display apparatus 400 determines where to display in the U display unit 407 using the U display specifying unit 404, determines the display content to be displayed on itself, and then displays the determined display content.

Next, the VE system 500 of FIG. 16 does not have the V function specifying unit 503, the V display specifying unit 504, or the V display content determining unit 505 of FIG. 15. Therefore, the VE system 500 of FIG. 16 is configured to create display information based on display data from the camera apparatus 200 with high affinity without specifying the function or display unit.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

Each embodiment, for example, can provide a control apparatus that is beneficial in operability of the imaging unit.

Each embodiment automatically specifies the function and display unit and determines the display content based on the transmitted and received information, but each embodiment is not limited to this example. For example, the function and display unit may be set, and the priority of the devices may be set. In communicably connecting each device, this embodiment transmits and receives support and nonsupport information on the function specifying unit, the display specifying unit, and the display content determining unit, and which device performs which function of the function specifying unit, the display specifying unit, and the display content determining unit may be determined based on that information. The above function may be set.

This application claims the benefit of Japanese Patent Application No. 2022-164402, filed on Oct. 13, 2022, which is hereby incorporated by reference herein in its entirety.

What is claimed is:

1. A control apparatus communicable with a unit including a display apparatus in an imaging system, the control apparatus comprising:
a communication device configured to communicate with the unit; and
a processor configured to make the communication device to transmit display data superimposed by the display apparatus to the unit based on specifying information for specifying the unit acquired by the communication device and information about a function of the display apparatus corresponding to the specifying information.

2. The control apparatus according to claim 1, wherein the processor is configured to generate the display data based on information about performance of the display apparatus corresponding to the specifying information.

3. The control apparatus according to claim 1, wherein the function is specified by a type of a user operating the unit.

4. The control apparatus described in claim 2, wherein the performance is specified by a type of the unit.

5. The control apparatus according to claim 1, wherein the processor generates the display data corresponding to the function.

6. The control apparatus described in claim 1, where the function relates to an operation content for imaging.

7. The control apparatus according to claim 1, wherein the function relates to a function of a user operating the unit.

8. The control apparatus according to claim 2, wherein the performance relates to at least one of a screen size, resolution, and pixel number of the display apparatus.

9. The control apparatus according to claim 1, wherein the processor generates the display data based on a communication frequency of information by the communication device.

10. The control apparatus according to claim 1, wherein the processor generates the display data based on a display frequency of information by the display apparatus.

11. The control apparatus according to claim 1, wherein the processor generates the display data based on information not displayed by the display apparatus.

12. The control apparatus according to claim 1, wherein the processor has information that associates the specifying information with information on a function of the display apparatus.

13. The control apparatus according to claim 2, wherein the processor has information that associates the specifying information with information on the performance of the display apparatus.

14. The control apparatus according to claim 1, wherein the communication device communicates with the unit through another unit.

15. An imaging system comprising:
the control apparatus according to claim 1; and
the unit.

16. The imaging system according to claim 15, wherein the control apparatus is included in one of a lens apparatus, an image pickup apparatus, an operation apparatus, a display dedicated apparatus, and a VE system, and
wherein the unit is included in another one of the lens apparatus, the image pickup apparatus, the operation apparatus, the display dedicated apparatus, and the VE system.

17. The imaging system according to claim 15, wherein the unit is specified in at least one of a lens apparatus, an image pickup apparatus, an operation apparatus, a display dedicated apparatus, and a VE system, and
wherein the display data is generated by one of the lens apparatus, the image pickup apparatus, the operation apparatus, the display dedicated apparatus, and the VE system.

18. The imaging system according to claim 15, wherein the processor determines a unit configured to perform at least one of specifying the unit and generating the display data.

19. A control method in a control apparatus communicable with a unit including a display apparatus in an imaging system, the control method comprising the steps of:
communicating with the unit; and
transmitting display data superimposed by the display apparatus to the unit based on specifying information for specifying the unit acquired by a communication and information about a function of the display apparatus corresponding to the specifying information.

20. A non-transitory computer-readable storage medium storing a program that causes a computer to execute the control method according to claim 19.
